(19) United States
(12) Patent Application Publication
(10) Pub. No.: US 2022/0309571 A1
(43) Pub. Date: Sep. 29, 2022

(54) DIGITAL SAVINGS BOX SYSTEM

(71) Applicant: Digital Corsair Disruption Inc., TOKYO (JP)

(72) Inventor: NARU KAMEI, Miura-shi (JP)

(21) Appl. No.: 17/290,628

(22) PCT Filed: Jul. 31, 2020
(86) PCT No.: PCT/JP2020/029508

§ 371 Date: Apr. 30, 2021

(30) Foreign Application Priority Data
May 22, 2020 (JP) 2020-089601

(51) Int. Cl. G06Q 40/02; G06Q 20/06; G06Q 20/10; G06Q 20/36

(52) U.S. Cl. CPC G06Q 40/02; G06Q 20/06; G06Q 20/108; G06Q 20/363

(57) ABSTRACT

It is an object of the present invention is to provide a computer system and application softwares for realizing a digital savings box in which money can be saved on a computer network, equipped with various functions of encouraging users to save money.

### TECHNICAL FIELD

The present invention relates to a computer system and application softwares for realizing a digital savings box in which money can be saved on a computer network, preferably equipped with various functions of encouraging users to save money.

### BACKGROUND ART

In this digital age, use of electronic money and online settlement have been common. Remittances and settlements are implemented often not by cash but by use of online banking, credit cards, electronic money and the like.

There has been a growing need for a system enabling not only remittances and settlements but also saving money, without using cash.

Patent Document 1 discloses an invention titled “An apparatus and a system for encashing deposits and savings”.

It employs an application software implemented on users' mobile terminals which enables the users to withdraw their deposits and savings using the existing internet banking systems.

Patent Document 2 discloses an invention titled “A system, method and program for saving”.

It employs a computer system and application softwares for realizing a digital savings box by which its users send and receive money with each other.

### PRIOR ART DOCUMENTS

### Patent Documents

Patent Document 1: Japanese Patent Application Laid-open No. 2017-120602.
Patent Document 2: Japanese Patent No. 6564101

### DISCLOSURE OF INVENTION

### Problems to be Solved by the Invention

Typical purposes of saving money, or setting aside some surplus money out of the living fund, are to have a reserve fund for a rainy day, or for covering specific future expenses. In case children save money for specific purposes, parents may well manage and monitor it so as to nurture their financial literacy. Saving money every day and month for specific purposes, per se, may be a little daily pleasure both for children and adults.

Although the systems and methods disclosed in the above-referenced prior art Patent Documents are able to provide functions to deposit and withdraw money, they fail to provide such functions as encouragement of saving, financial education and parental control on use of money.

In consideration of the above, it is an object of the present invention is to provide a computer system and application softwares for realizing a digital savings box in which money can be saved on a computer network, equipped with various functions of encouraging users to save money.

### Means for Solving the Problems

As a result of repeated studies zealously in consideration of the above problems, the inventors have come up with an idea of an application software realizing a digital saving box available on a computer network which, at the same time, is capable of promoting encouragement of saving and financial education for its users. Thus invented is the present invention, which is to be described below in details.

The present invention thus provides a digital savings box system comprising: a user information database storing user attributes information; a savings box database storing information of the saving balance of at least one savings box owned by a user; an affiliator information database storing information for transferring fund to and from at least one affiliated financial institution and/or at least one affiliated electronic money issuer; a savings box managing unit editing the information of savings box(es) stored in said savings box database upon receiving an operation request by the user of the savings box(es); a reception/payment processing unit processing money reception/payment between a savings box and another savings box or between a user's savings box and an affiliated financial institution/affiliated electronic money issuer on the basis of the information stored in said savings box database upon receiving such reception/payment operation request by the user or according to a prescribed condition; and an affiliator communication unit transferring fund to and from said affiliated financial institution(s)/affiliated electronic money issuer(s) in accordance with the money reception/payment operation by said reception/payment processing unit with reference to the information in said affiliator information database; wherein said user information database stores information of restriction of operation by each user to his savings box(es); said savings box database stores information of restriction of operation on each savings box; and said savings box managing unit processes a user's operation request to a his savings box in accordance with the restriction of operation imposed on the user and his savings box.

The digital savings box system according to the present invention is characterized in that said savings box database stores information of reception/payment history of each savings box.

The digital savings box system according to the present invention is characterized in that said savings box managing unit is capable of creating in said savings box database a savings box owned by more than one user for which each restriction of operation is imposed on each of the users.

The digital savings box system according to the present invention is characterized in that said savings box managing unit obtains from a user, when processing money reception/payment upon the user's request, information associated therewith and stores the associated information in said savings box database, said savings box managing unit being capable of, upon the user's request, allowing the user to browse the associated information and/or reception/payment history information of the user's saving box(es).

The digital savings box system according to the present invention is characterized in that said savings box managing unit is capable of, upon the user's request, allowing the user to implement at least one of the operations on the user's saving box(es) including money reception/payment, creation/editing/deletion of the user's saving box(es), and creation/editing/deletion of restriction of operation on the user's saving box(es).

The digital savings box system according to the present invention is characterized in that said user information database stores information of the users' roles such as managing user and managed user, and information of restriction of operation by each user to each savings box based on the user's role, and said savings box managing unit accepts an operation request by the user of the savings box(es) in compliance with the restriction of operation on the savings box(es).

The digital savings box system according to the present invention is characterized in that it further comprises a saving encouraging unit encouraging the users' money saving based on the information of the users stored in said user information database, said saving encouraging unit providing with the user of the savings box(es) information of the saving target(s) or the saving plan(s) which the user has set such as the target amount, the achievement rate of target, the saving plan and the achievement rate of plan.

The digital savings box system according to the present invention is characterized in that said saving encouraging unit allows the users having similar or common saving target(s) or the saving plan(s) to mutually view the information of their saving target(s) or plan(s) such as the target amount, the achievement rate of target, the saving plan and the achievement rate of plan.

The digital savings box system according to the present invention is characterized in that said saving encouraging unit allows the users having similar or common saving target(s) or the saving plan(s) to mutually view the information of their saving target(s) or plan(s) such as the target amount, the achievement rate of target, the saving plan and the achievement rate of plan.

The digital savings box system according to the present invention is characterized in that said saving encouraging unit proposes to the users a saving target or a saving plan and allows the users adopting the saving target or saving plan to mutually view the information of their the achievement rate of target or the achievement rate of plan.

The digital savings box system according to the present invention is characterized in that said saving encouraging unit gives reward to the users achieving their saving target(s) or plan(s) in the amount proportional to the achievement rates.

Advantages

The present invention provides a computer system and application softwares for realizing a digital savings box in which money can be saved on a computer network, equipped with various functions of encouraging users to save money.

### BRIEF DESCRIPTION OF DRAWINGS

FIG. 1 is a schematic view showing the overall configuration of a digital savings box system according to an embodiment of the present invention.

FIG. 2 is a schematic view showing an exemplary configuration of the savings box server shown in FIG. 1.

FIG. 3 is a sequence diagram showing the flow of processing a user's depositing money into his savings box(es).

FIG. 4 is a sequence diagram showing the flow of processing a user's withdrawing money from his savings box(es).

FIG. 5 is a sequence diagram showing the flow of processing money transfer from a user's savings box to another user's in the present savings box system.

FIG. 6 is a sequence diagram showing the flow of processing money transfer from a user's savings box to another user's bank account or electronic money account in the present savings box system.

FIG. 7 is a sequence diagram showing the flow of processing scheduled or appointed settlements set up by a user so as to transfer money to and from the external systems of the affiliators in the present savings box system.

### BEST MODES FOR CARRYING OUT THE INVENTION

Described hereinafter with reference to the attached drawings are detailed embodiments of the digital savings box system according to the present invention. In the figures, like reference numerals refer to like members which have similar basic composition and operation.

System Configuration

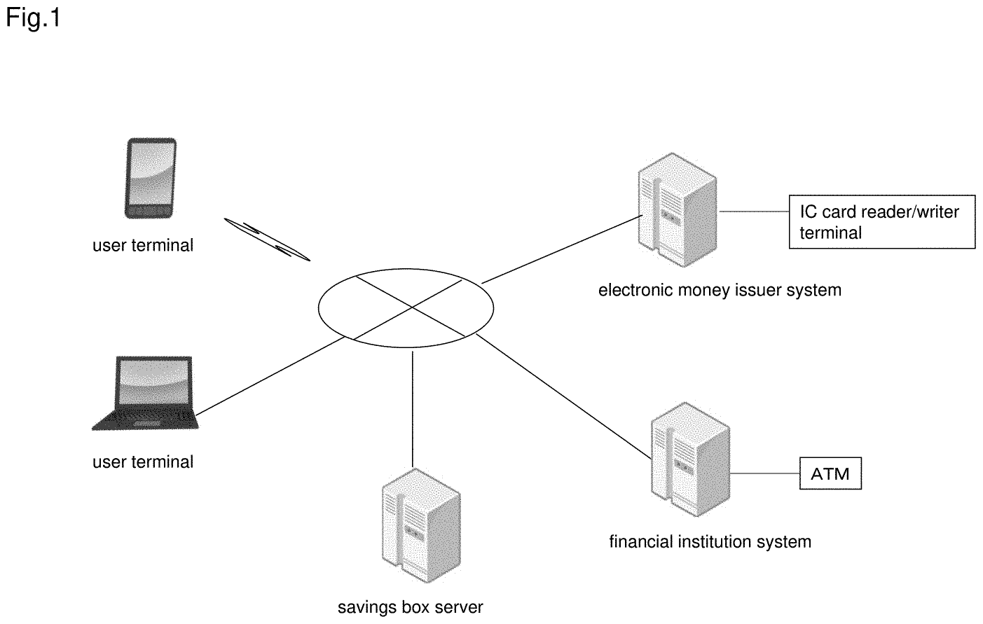

FIG. 1 is a schematic view showing the overall configuration of a digital savings box system according to an embodiment of the present invention.

As shown in FIG. 1, the system consists of a savings box server, one or more financial institution systems, one or more electronic money issuer systems, and user terminals. Those are mutually communicable via networks such as the Internet.

The savings box server plays a central role in the digital savings box system according to an embodiment of the present invention. The details are to be described in the below.

The financial institution systems are online computer systems of city banks, local banks, online banks (and also trust banks, securities companies, insurance companies, loan companies, etc.) for implementing online settlement among them and with other external institutions. These systems are connected to ATMs available for to users.

The electronic money issuer systems are online computer systems of electronic money issuers for implementing online settlement among them and with other external institutions. The “electronic money” herein includes those in the form of IC cards, magnetic cards, application software on smartphones, prepaid cards and the like. Some of the electronic money issuer systems are connected to IC card reader/writer terminals available to the users.

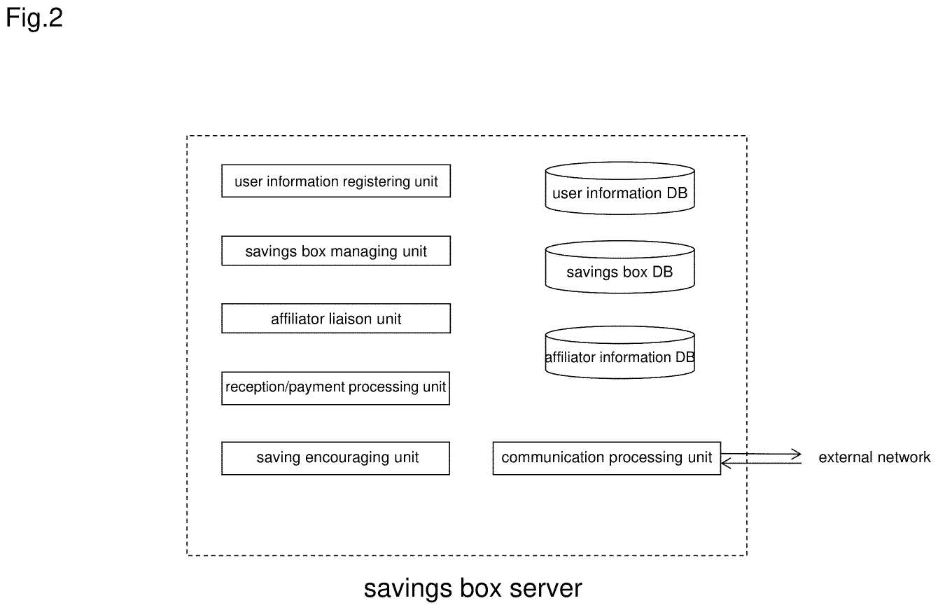

FIG. 2 is a schematic view showing an exemplary configuration of the savings box server shown in FIG. 1.

As shown in FIG. 1, the savings box server comprises a user information database, a savings box database, an affiliator information database, a user information registering unit, a savings box managing unit, an affiliator liaison unit, a reception/payment processing unit, a saving encouraging unit and a communication processing unit.

The user information database stores user attributes information, user authentication information, user identification information recognizable by the affiliators (affiliated financial institutions, electronic money issuers, etc.), and information necessary to implement encouragement of money saving as described below.

The savings box database stores information of the users saving boxes. The information includes saving balance, pay-in/out history, identifiers of the saving boxes, restriction of operation set on each saving box or on each user.

The affiliator information database stores information for transferring fund to and from external institutions such as the affiliated financial institutions and affiliated electronic money issuers shown in FIG. 1. The administrator of the system is preferably a legally-licensed fund transfer specialists such that the affiliator information database is legally and duly administrated.

The user information registering unit processes, upon a user's request, registration, editing and deletion of the user's information in the user information database. It also processes user authentication.

The savings box managing unit processes in the savings box database, upon a user's request, balance inquiry, creation, editing and deletion of saving box(es), and creation, editing and deletion of restriction of operation on users' saving boxes.

The affiliator communication unit processes fund transfer to and from the affiliated financial institutions/affiliated electronic money issuers shown in FIG. 1 with reference to the information in the affiliator information database.

The reception/payment processing unit processes in the savings box database, upon a user's request, money reception/payment as a result of fund transfer to and from the affiliated financial institutions/affiliated electronic money issuers.

The saving encouraging unit provides users (via their user terminals) with information so as to encourage the users' money saving based on the information of the users stored in the user information database and the savings box database.

The communication processing unit controls wired or wireless communication means so as to enable communication with the user terminals and other external systems.

System Operation

Below described in details are the functions and operations performed in a digital savings box system according to an embodiment of the present invention.

(1) Reception/Payment

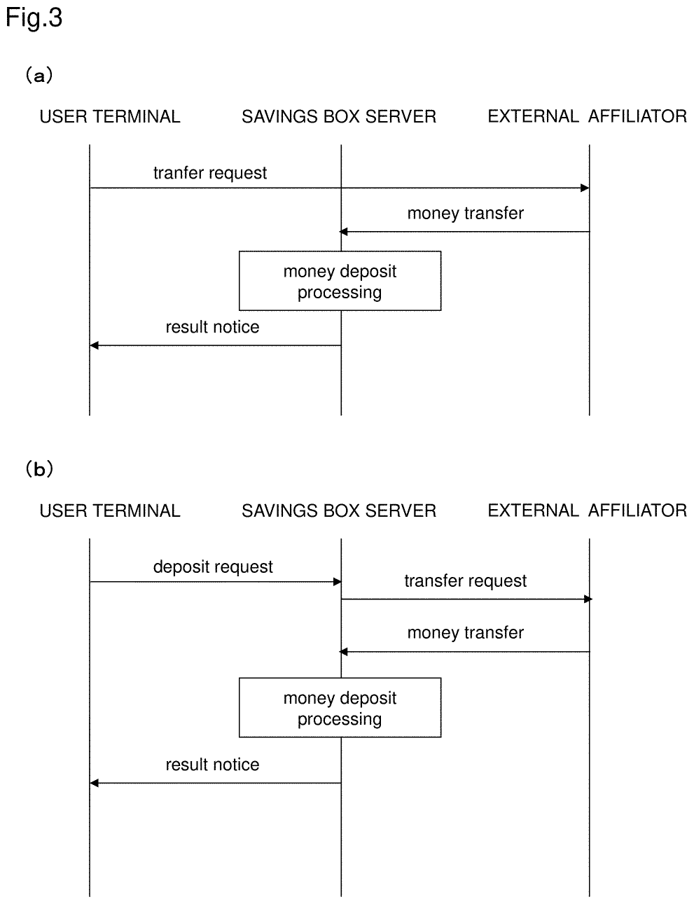

FIG. 3 is a sequence diagram showing the flow of processing a user's depositing money into his savings box(es) in the present savings box system.

As shown in FIG. 3(a), a user terminal sends a transfer request to one of the external systems of the affiliators (such as financial institutions and electronic money issuers) requesting it to transfer money into a savings box (any one of the user's savings box(es)) in the present savings box system. That is to request transferring a certain amount of money from one of the user's bank accounts or electronic money accounts to the administrator of the present savings box system, who is preferably a legally-licensed fund transfer specialist. Such a transfer request may be sent with additional information such as the user's designation of the saving box, the user's memo and the like. Upon the money being transferred from the external systems to the present savings box system, the affiliator communication unit and the reception/payment processing unit recognize the reception of money and the savings box managing unit identifies, with reference to the user information database, the user who made the transfer. The savings box managing unit increases the balance of the designated savings box in the savings box database in the amount equivalent to the money transferred (or fees may be deducted). The savings box managing unit notifies the user of the result of the deposit request.

Alternatively as shown in FIG. 3(b), a user terminal sends a deposit request to the present savings box system. In this case, the affiliator communication unit with reference to the affiliator information database forwards a transfer request to the external system of the designated affiliator. The transfer request is processed accordingly as described in the above.

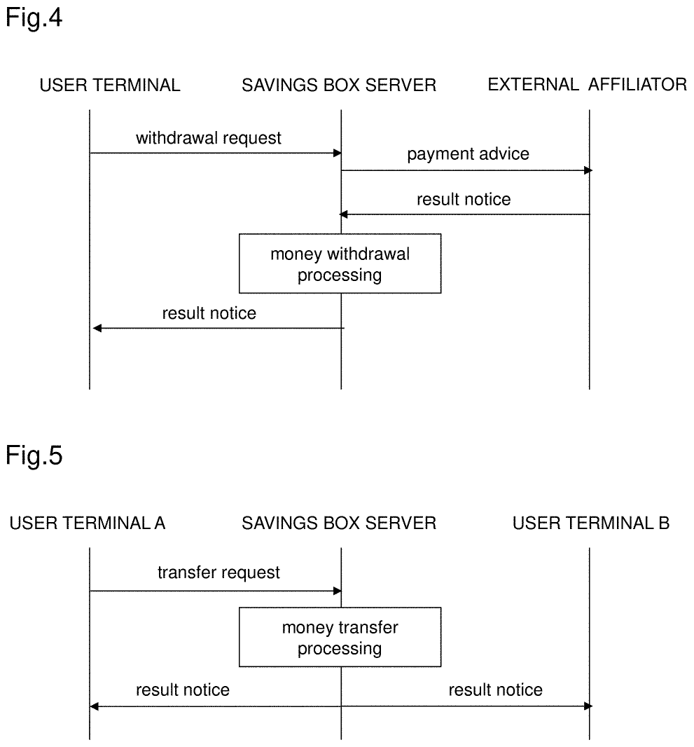

FIG. 4 is a sequence diagram showing the flow of processing a user's withdrawing money from his savings box(es) in the present savings box system.

As shown in FIG. 4, a user terminal sends a withdrawal request to the present savings box system. That is to request transferring a certain amount of money from one of the user's savings box(es) to one of the user's bank accounts or electronic money accounts. The reception/payment processing unit and the affiliator communication unit send to the external system of the designated affiliator a payment advice on the money transfer into the designated account. At the same time, the administrator of the present savings box system implements the money transfer into the designated account. Upon completion of the money transfer, the savings box managing unit decreases the balance of the designated savings box in the savings box database in the amount equivalent to the money transferred (or fees may be deducted). The savings box managing unit notifies the user of the result of the withdrawal request.

(2) Transferring Money Between Users

FIG. 5 is a sequence diagram showing the flow of processing money transfer from a user's savings box to another user's in the present savings box system.

As shown in FIG. 5, user A operates his user terminal A to send to the present savings box system a request to transfer money from one of the saving box(es) of user A to that of user B. That is to request transferring a certain amount of money from one of the savings box(es) of user A to that of user B. The savings box managing unit decreases the balance of the designated savings box of user A in the savings box database in the amount equivalent to the money transferred, and increases the balance of the designated savings box of user B in the same amount (or fees may be deducted). The savings box managing unit notifies user A and user B of the result of the money transfer request.

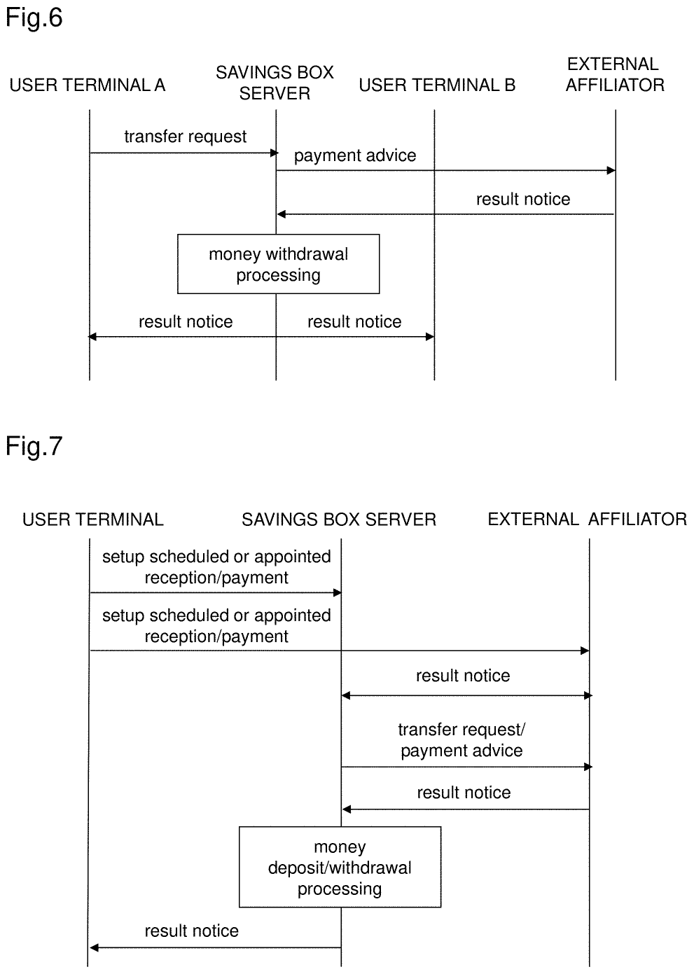

FIG. 6 is a sequence diagram showing the flow of processing money transfer from a user's savings box to another user's bank account or electronic money account in the present savings box system.

As shown in FIG. 6, user A operates his user terminal A to send to the present savings box system a request to transfer money from one of the saving box(es) of user A to one of the bank accounts or electronic money accounts of user B. That is to request transferring a certain amount of money from one of the savings box(es) of user A to one of the bank accounts or electronic money accounts of user B. The reception/payment processing unit and the affiliator communication unit send to the external system of the designated affiliator a payment advice on the money transfer into the designated account of user B. At the same time, the administrator of the present savings box system implements the money transfer into the designated account of user B. Upon confirming completion of the money transfer, the savings box managing unit decreases the balance of the designated savings box of user A in the savings box database in the amount equivalent to the money transferred (or fees may be deducted). The savings box managing unit notifies user A and user B of the result of the money transfer request.

(3) Scheduled or Appointed Settlement

FIG. 7 is a sequence diagram showing the flow of processing scheduled or appointed settlements set up by a user so as to transfer money to and from the external systems of the affiliators in the present savings box system.

As shown in FIG. 7, a user operates his user terminal to set up a scheduled or appointed reception/payment. A user may, for example, set up a scheduled reception such that a predetermined amount of money is transferred from a predetermined bank account or electronic money account of the user into one of his savings box(es) once every month. A user may set up a scheduled payment such that a predetermined amount of money is transferred from one of his savings box(es) into a predetermined bank account or electronic money account of his or other's. A user may set up a scheduled money transfer such that a predetermined amount of money is transferred between one of his savings box(es) and other's on a regular basis.

The above-described money transfer and settlement functions using the present savings box system enables users without bank accounts or credit cards to make settlement with other users, including regular basis settlement.

(4) Managing Saving Boxes

In addition to the above-described basic functions, the present savings box system provides further user-convenient functions as described below.

(4-1) Parental Control

The present savings box system enables it to set users different roles such as managing user (e.g. parent) and managed user (e.g. child) such that a managing user can manage operation by certain managed user(s) on certain savings box(es). The present system notifies a managing user of a managed user's attempting certain restricted operation on his savings box(es), and prompts the managing user to approve or deny the operation. The user information database stores information of the corresponded managing users and managed user(s) and information of restriction of operation imposed on each managed user. The savings box managing unit with reference to the above information in the user information database processes the restriction/acceptance of operation in the above-described manner.

Alternatively, the managing user may predetermine detailed conditions such as restriction of money amount deposited/withdrawn in each savings box, time period and the like only in accordance with which the managed user(s) are allowed to make operation on their savings box(es). Making detailed settings on respective savings box(es) enables a parent as a managing user to exercise attentive parental control on his child(ren) as managed user(s).

(4-2) Shared Saving Boxes

The present savings box system allows more than one users to share a savings box. The savings box may be shared among family members, friends or club members. The user information database may store information of the users sharing the same savings box(es) and the range of authority to operate the same savings box(es) set on each user, e.g. types of operation allowed for the user, limit amount of money the user is allowed to deposit/withdraw, and the like. The savings box managing unit with reference to the above information in the user information database processes the users' operation on their shared savings box(es) in the above-described manner.

(4-3) Deposit/Withdrawal Memo

The present savings box system enables a user to record a memo corresponding with a deposit/withdrawal operation in his saving box. The system also allows a user to browse deposit/withdrawal history information in his saving box. The savings box managing unit with reference to the above information in the savings box database processes the user's operation on his savings box in the above-described manner.

(5) Encouraging Money Saving

The present savings box system further provides functions to encourage users' money saving as described below.

(5-1) Saving Target

The present savings box system provides a user with a plenty of functions to manage the user to achieve his saving target(s) or plan(s), e.g. saving prescribed amount of money once every month. Below are detailed examples.

i) Provide on the user display the information of the target amount, the achievement rate of target, the saving plan, the achievement rate of plan and the like.
ii) Provide on the user display graph presentation showing the target amount, the achievement rate of target, the saving plan, the achievement rate of plan and the like.
iii) Impose restriction on withdrawal operation by a user who is behind his saving target(s) or plan(s) to a predetermined extent.
iv) Provide on the user display encouraging messages depending on the progress of his saving target(s) or plan(s).
v) Provide means for the users to communicate with other users having similar or common saving target(s) or plan(s) and allow them to mutually view their saving target(s) or plan(s) so as to invoke peer competition among them. Preferably provide a chat tool for this purpose.
vi) Implement campaigns to incentivize the users to save money, e.g. give rewards to those users who have achieved a certain saving targets or plans which the administrator of the system proposed.

The savings box managing unit and the saving encouraging unit with reference to the user information database and the savings box database processes the above-described operations.

(5-2) Financial Literacy Education

The present savings box system provides users with information to nurture their financial literacy in correspondence with their attribute information and their saving targets or plans.

The savings box managing unit and the saving encouraging unit with reference to the user information database and the savings box database processes the above-described operations.

The present savings box system will effectively implement financial literacy education by, for example, providing with such information for users of certain ages participating the above-described function:

vi) Implement campaigns to incentivize the users to save money, e.g. give rewards to those users who have achieved a certain saving targets or plans which the administrator of the system proposed.

While embodiments and examples of the digital savings box system according the present invention are described in the above, no limitation of the scope of the present invention is thereby intended. Those skilled in the art would contemplate various alterations and modifications on the structures and functions of the hardwares and softwares on the mobile terminals within the scope of the present invention.

### INDUSTRIAL APPLICABILITY

As shown in FIGS. 1 to 7, the digital savings box system according to the present invention is attained by the operations of the OS, application software, databases, network systems and the like which are constructed on the hardware resources of computers comprising CPUs, memories, auxiliary storage devices, display devices, I/O devices and the like. The system performs, using the above hardware resources, information processing of managing money reception/payment and encouraging money savings. The present invention, as such, constitutes a creation of technical ideas utilizing a law of nature, which can be utilized in the field of software, information communication and the like.

1. A digital savings box system comprising:
a user information database storing user attributes information;
a savings box database storing information of the saving balance of at least one savings box owned by a user;
an affiliator information database storing information for transferring fund to and from at least one affiliated financial institution and/or at least one affiliated electronic money issuer;
a savings box managing unit editing the information of savings box(es) stored in said savings box database upon receiving an operation request by the user of the savings box(es);
a reception/payment processing unit processing money reception/payment between a savings box and another savings box or between a user's savings box and an affiliated financial institution/affiliated electronic money issuer on the basis of the information stored in said savings box database upon receiving such reception/payment operation request by the user or according to a prescribed condition; and
an affiliator communication unit transferring fund to and from said affiliated financial institution(s)/affiliated electronic money issuer(s) in accordance with the money reception/payment operation by said reception/payment processing unit with reference to the information in said affiliator information database; wherein said user information database stores 5 information of restriction of operation by each user to his savings box(es);
said savings box database stores information of restriction of operation by each user to each savings box; and
said savings box managing unit processes a user's operation request to a his savings box in accordance with the restriction of operation imposed on the user and his savings box.

2. The digital savings box system as set forth in claim 1 wherein said savings box database stores information of reception/payment history of each savings box.

3. The digital savings box system as set forth in claim 1 wherein said savings box managing unit is capable of creating in said savings box database a savings box owned by more than one user and of setting restriction of operation imposed on each of the users.

4. The digital savings box system as set forth in claim 1 wherein said savings box managing unit obtains from a user, when processing money reception/payment upon the user's request, information associated therewith and stores the associated information in said savings box database, said savings box managing unit being capable of, upon the user's request, allowing the user to browse the associated information and/or reception/payment history information of the user's saving box(es).

5. The digital savings box system as set forth in claim 1 wherein said savings box managing unit is capable of, upon the user's request, allowing the user to implement at least one of the operations on the user's saving box(es) including money reception/payment, creation/editing/deletion of the user's saving box(es), and creation/editing/deletion of restriction of operation on the user's saving box(es).

6. The digital savings box system as set forth in claim 1 wherein said user information database stores information of the users' roles such as managing user and managed user, and information of restriction of operation by each user to each savings box based on the user's role, and said savings box managing unit accepts an operation request by the user of the savings box(es) in compliance with the restriction of operation on the savings box(es).

7. The digital savings box system as set forth in claim 1 further comprising a saving encouraging unit encouraging the users' money saving based on the information of the users stored in said user information database and the savings box database, said saving encouraging unit providing with the user of the savings box(es) information of the saving target(s) or the saving plan(s) which the user has set such as the target amount, the achievement rate of target, the saving plan and the achievement rate of plan.

8. The digital savings box system as set forth in claim 7 wherein said saving encouraging unit tightens the restriction of operation by the user to the savings box(es) in case the achievement rate of target or plan is lower than 20 a predetermined standard.

9. The digital savings box system as set forth in claim 7 wherein said saving encouraging unit allows the users having similar or common saving target(s) or the saving plan(s) to mutually view the information of their saving target(s) or plan(s) such as the target amount, the achievement rate of target, the saving plan and the achievement rate of plan.

10. The digital savings box system as set forth in claim 7 wherein said saving encouraging unit proposes to the users a saving target or a saving plan and allows the users adopting the saving target or saving plan to mutually view the information of their the achievement rate of target or the achievement rate of plan.

11. The digital savings box system as set forth in claim 10 wherein said saving encouraging unit gives reward to the users achieving their saving target(s) or plan(s) in the amount proportional to the achievement rates.

12. The digital savings box system as set forth in claim 2 wherein said savings box managing unit is capable of creating in said savings box database a savings box owned by more than one user and of setting restriction of operation imposed on each of the users.

13. The digital savings box system as set forth in claim 8 wherein said saving encouraging unit allows the users having similar or common saving target(s) or the saving plan(s) to mutually view the information of their saving target(s) or plan(s) such as the target amount, the achievement rate of target, the saving plan and the achievement rate of plan.

14. The digital savings box system as set forth in claim 8 wherein said saving encouraging unit proposes to the users a saving target or a saving plan and allows the users adopting the saving target or saving plan to mutually view the information of their the achievement rate of target or the achievement rate of plan.

15. The digital savings box system as set forth in any one of claim 2 wherein said savings box managing unit obtains from a user, when processing money reception/payment upon the user's request, information associated therewith and stores the associated information in said savings 5 box database, said savings box managing unit being capable of, upon the user's request, allowing the user to browse the associated information and/or reception/payment history information of the user's saving box(es).

16. The digital savings box system as set forth in any one of claim 2 wherein said savings box managing unit is capable of, upon the user's request, allowing the user to implement at least one of the operations on the user's saving box(es) including money reception/payment, creation/editing/deletion of the user's saving box(es), and creation/editing/deletion of restriction of operation on the user's saving box(es).

17. The digital savings box system as set forth in claim 2 wherein said user information database stores information of the users' roles such as managing user and managed user, and information of restriction of operation by each user to each savings box based on the user's role, and said savings box managing unit accepts an operation request by the user of the savings box(es) in compliance with the restriction of operation on the savings box(es).

18. The digital savings box system as set forth in claim 2 further comprising a saving encouraging unit encouraging the users' money saving based on the information of the users stored in said user information database and the savings box database, said saving encouraging unit providing with the user of the savings box(es) information of the saving target(s) or the saving plan(s) which the user has set such as the target amount, the achievement rate of target, the saving plan and the achievement rate of plan.

19. The digital savings box system as set forth in claim 3 further comprising a saving encouraging unit encouraging the users' money saving based on the information of the users stored in said user information database and the savings box database, said saving encouraging unit providing with the user of the savings box(es) information of the saving target(s) or the saving plan(s) which the user has set such as the target amount, the achievement rate of target, the saving plan and the achievement rate of plan.

20. The digital savings box system as set forth in claim 4 further comprising a saving encouraging unit encouraging the users' money saving based on the information of the users stored in said user information database and the savings box database, said saving encouraging unit providing with the user of the savings box(es) information of the saving target(s) or the saving plan(s) which the user has set such as the target amount, the achievement rate of target, the saving plan and the achievement rate of plan.
